(19) United States
(12) Patent Application Publication
(10) Pub. No.: US 2009/0052208 A1
(43) Pub. Date: Feb. 26, 2009

(54) Apparatus to Extend HDMI Connections over a Single Ethernet CAT Cable

(76) Inventor: Changrong Li, Austin, TX (US)

Correspondence Address: Changrong Li, 10710 Cassia Dr., Austin, TX, 78759, US

(21) Appl. No.: 12/196,278

(22) Filed: Aug. 21, 2008

Related U.S. Application Data
(60) Provisional application No. 60/968,046, filed on Aug. 25, 2007.

(51) Int. Cl. H02M 7/66

(52) U.S. Cl. 363/13

(57) ABSTRACT

This invention is to use a single standard unshielded or shielded Ethernet CAT cable, such as CAT5, CAT5e, CAT6 and similar cable, to extend original digital video signals over long distances. The Ethernet CAT cable can be installed with the required length easily and terminated in the field with simple tools. The Ethernet cable is the standard communication wiring in modern buildings. On the contrary, HDMI cable must be pre-terminated in the factory and is extremely difficult to install in buildings. HDMI video signals contain three pairs of CML video signals, one pair of high-speed clock signals, and three control signals. Each video signal has a data rate over 1.6 Gbps, and one of the control signals is bi-directional. Sending these signals over a single Ethernet CAT cable is very difficult. This invention presents an apparatus to extend HDMI signals over a single Ethernet CAT cable. The present invention is able to extend 1080p video over more than 150 feet, and to reliably extend 1080i over more than 200 feet with HDCP capability over a single unshielded or shielded Ethernet CAT cable.

This application claims the benefits of U.S. Provisional Application No. 60/968,046, filed on the 25^{th} day of Aug. 2007. This application is related to U.S. Non-Provisional Application Ser. No. 12/189,109, filed on the ₈^{th} day of Aug. 2008.

### FIELD OF THE INVENTION

The present invention relates to the transport of the high-definition video from the source to the display using a single unshielded or shielded Ethernet CAT cable over long distances, or to displays with daisy-chaining multiple receivers through multiple single cables over longer distances.

### BACKGROUND OF THE INVENTION

High-definition video from the source to the display or displays may be connected through different cables. Examples of these cables are HDMI or DVI cables.

HDMI (High-Definition Multimedia Interface) is a proprietary all-digital audio/video interface capable of transmitting uncompressed video streams. HDMI is compatible with HDCP (High-bandwidth Digital Content Protection) digital rights management technology. HDMI provides an interface between any compatible digital audio/video source, such as a set-top box, a Blu-ray DVD player, an HD DVD player, a PC, a video game console or an AV receiver and a compatible digital audio and/or video monitor, such as a digital television.

The HDMI interface is developed to transport high-speed digital video signals over relatively short distances using special HDMI cables. As the distance increases, the quality of the video degrades rapidly and the cost of the cable increases dramatically.

Transmitting high-definition video over long distances without degrading the quality of the video signals becomes challenging and important, especially over a shielded or unshielded Ethernet CAT cable, which is widely available and well accepted as a standard communication medium.

### SUMMARY OF THE INVENTION

The present invention relates to the transport of high-definition video from the source to the display or displays using an unshielded or shielded Ethernet CAT cable over long distances. The present invention converts the original DC coupled CML (Current Mode Logic) video signals to AC coupled differential signals, and uses common mode signaling to carry the control signals.

### BRIEF DESCRIPTION OF THE DRAWINGS

The transmitter explained in the drawings is a reference to an embodiment of the transmitter related to the invention. The receiver explained in the drawings is a reference to an embodiment of the receiver related to the invention.

FIG. 1 illustrates, in a simplified and representative form, a typical point-to-point application of the present invention, in which one video source is extended to one display over a single Ethernet CAT cable.

FIG. 2 shows high-level function blocks of the transmitter.

FIG. 3 depicts the circuitry used to convert the CML clock signals into AC coupled differential clock signals for the RJ45 differential video signals. This establishes the ground reference between the transmitter and the receiver.

FIG. 4 depicts the circuitry used to convert one of the CML differential video signals, TMDS_D2±, into one of the RJ45 differential signals, RJ45_D2±. The circuitry also multiplexes the power supply to provide power to the receiver.

FIG. 5 shows the circuitry used to convert one of the CML video signals, TMDS_D0±, into one of the RJ45 differential signals, RJ45_D0±. The control signals, SDA, will be multiplexed into or de-multiplexed from the RJ45_D0±, depending on the SDA_multiplex signal.

FIG. 6 illustrates the circuitry used to convert one of the CML video signals, TMDS_D1±, into one of the RJ45 differential signals, RJ45_D1±. It also multiplexes one of the control signals, SCL_Tx, over the RJ45 differential video signal.

FIG. 7 depicts the major function blocks in the receiver.

FIG. 8 illustrates the circuitry used to convert to the CML differential clock signals from the RJ45 differential clock signals. This establishes the ground reference between the transmitter and the receiver.

FIG. 9 illustrates the circuitry used to de-multiplex the power from the video signal to get power from the transmitter. The Vin can be converted into the required voltage with a simple linear regulator or a DC-DC converter.

FIG. 9 also illustrates the circuitry used to convert one of the RJ45 differential video signals, RJ45_D2±, into one of the CML differential video signals, TMDS_D2±.

FIG. 10 illustrates the circuitry used to convert one of the RJ45 differential video signals, RJ45_D1±, into one of the CML differential video signals, TMDS_D1±. It de-multiplexes one of the control signals, SCL_Rx, from the RJ45 differential video signals received.

FIG. 11 illustrates the circuitry to convert one of the RJ45 differential signals RJ45_D0±, into one of the CML differential signals, TMDS_D0±. The control signals, SDA, will be multiplexed into or de-multiplexed from the RJ45_D0±, depending on the SDA_multiplex signal.

### DETAILED DESCRIPTION

The transmitter explained below is a reference to an embodiment of the transmitter related to the invention. The receiver explained below is a reference to an embodiment of the receiver related to the invention.

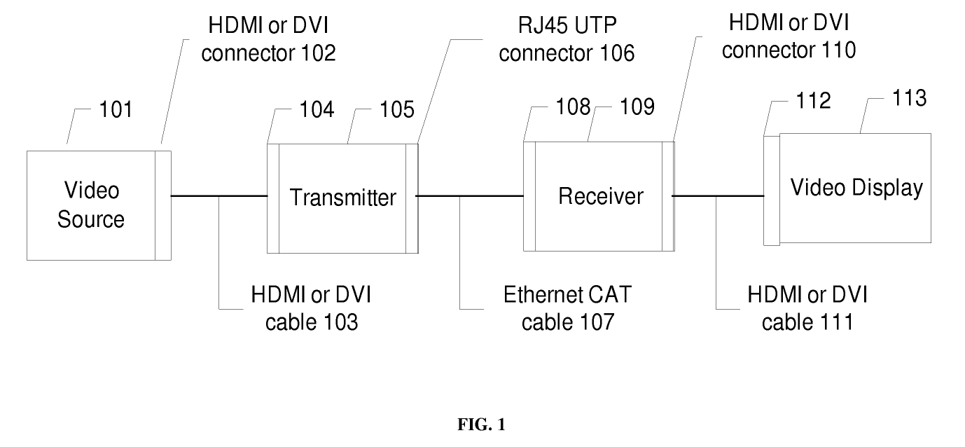

In FIG. 1, video source 101 is connected to HDMI or DVI connector 102 as a video output port. Typically, video source 101 is a DVD player, HD DVD player, Blu-ray player, the cable TV set-top box, satellite TV set-top box or computer.

The proper cable 103 matches video port 102 on video source 101 and video port 104 on transmitter 105. Typically, the proper cable 103 is a straight HDMI cable, straight DVI cable, HDMI to DVI adapter cable, or DVI to HDMI adapter cable.

Transmitter 105 in the present invention includes the driver and signal converters needed to transmit and receive digital video signals and control signals over UTP cable 107. Typically, it has HDMI or DVI connector 104 as its video and control signals input and output port depending on the targeted applications, and one or two RJ45 UTP connect/connectors 106 as its video and control signals output and input port/ports.

UTP cable 107, typically, is one CAT-5, CAT-6 or other special UTP cable.

Receiver 109 based on the present invention includes the drivers and signal converters needed to transmit and receive digital video signals and control signals over UTP cable 107. Typically, receiver 109 has one or two RJ45 UTP connector/connectors 108 as its video and control signals input and output ports, and a HDMI or DVI connector 110 as its video and control signals input and output port depending on the targeted applications 113.

The proper cable 111 matches video port 112 on display 113 and video port 110 on receiver 109. Typically, cable 111 is a straight HDMI cable, straight DVI cable, HDMI to DVI adapter cable, or DVI to HDMI adapter cable.

Display 113 is used to display the target application, video for example. Typically, it is an HDTV, including LCD TV, Plasma TV, and DLP TV, or computer monitor, which includes LCD display and other flat-panel displays.

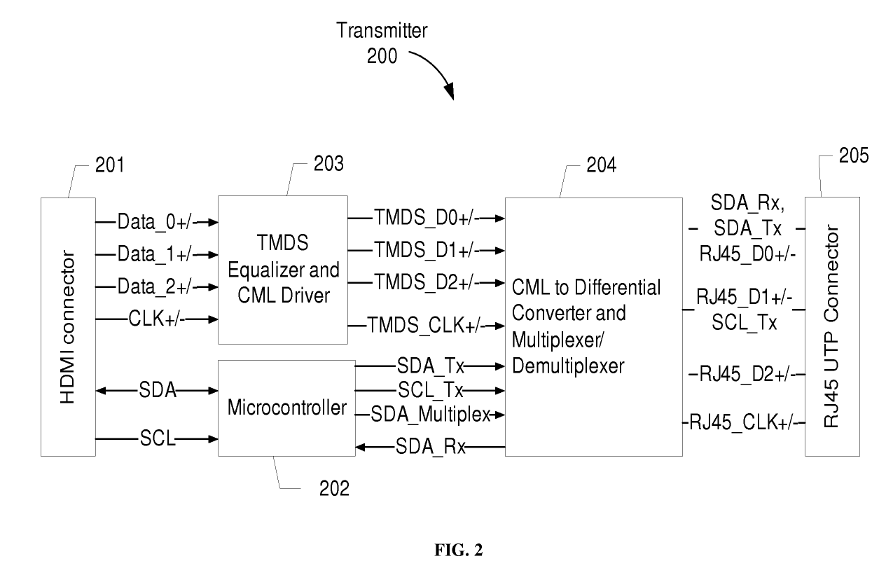

In FIG. 2, model 200 depicts the major function blocks in an embodiment of the transmitter, such as Transmitter block 103 in FIG. 1.

HDMI connector 201 functions as a connection port connected using a cable, such as the HDMI or DVI cable 102 in FIG. 1. The DC coupled differential video signals are received through HDMI or DVI cable.

The HDMI contains three pairs of digital video signals, one pair of high-speed clock signals, and three control signals. The digital video signals received from the HDMI connector are data_0±, data_1±, and data_2±. The high-speed differential clock signals are CLK±. And the control signals related to the transmitter in this invention are SDA and SCL.

As an embodiment of the TMDS (Transition Minimized Differential Signaling) Equalizer and CML (Current Mode Logic) Driver 203, it processes the DC coupled differential video signals received from the connection port 201, such as data_0±, data_1±, and data_2±, and converts them to the CML differential video signals as TMDS_D0±, TMDS_D1±, and TMDS_D2±.

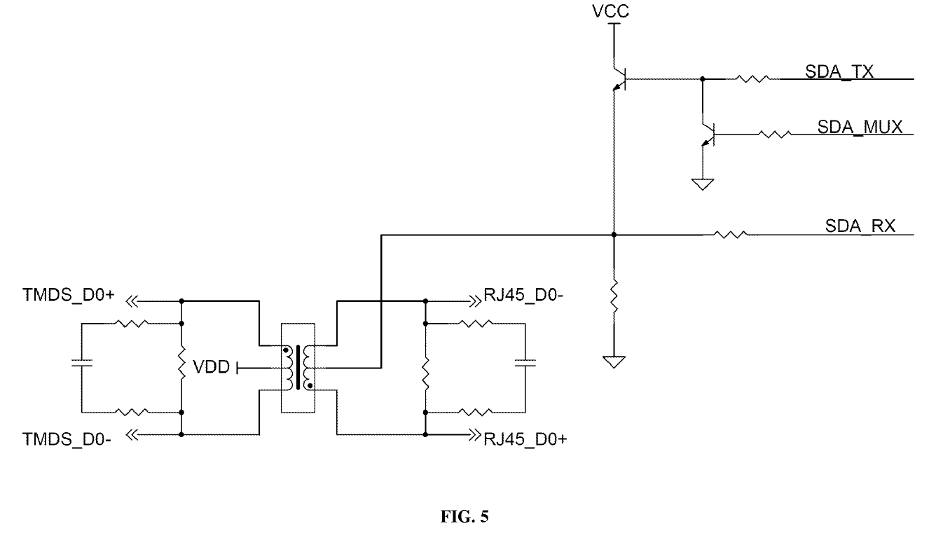

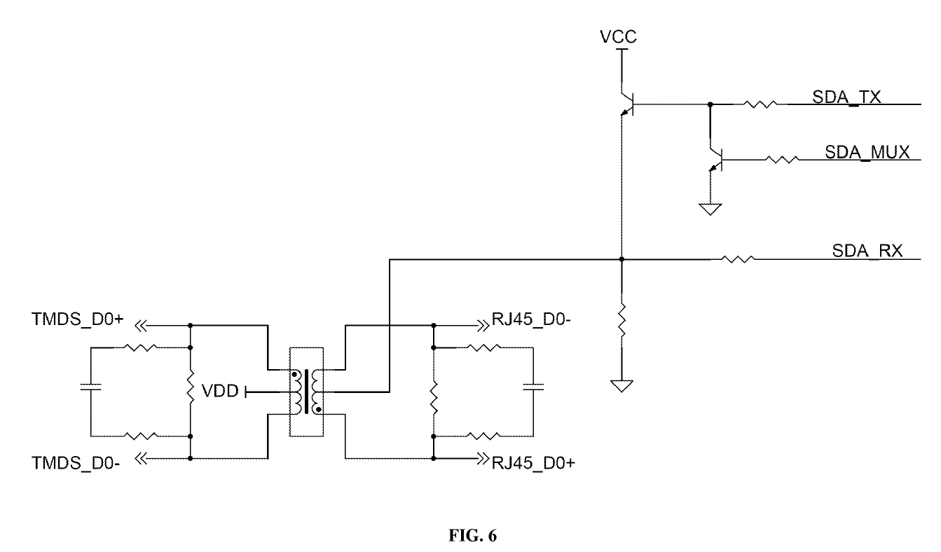

CML to Differential Converter and Multiplexer/Demultiplexer 204 therefore converts the DC coupled CML video signals, TMDS_D0±, TMDS_D1±, and TMDS_D2±, into the AC coupled differential signals, RJ45_D0±, RJ45_D1±, and RJ45_D2±. It also uses common mode signaling to carry three of the control signals, such as SCL_Tx in FIG. 6 and SDA_Tx, SDA_Rx in FIG. 5, under the supervision of micro-controller 202. Common mode signaling is realized by using the center-tap of the wide-band impedance matching transformers.

Micro-controller 202 selects control signals from HDMI or DVI connector 201 and enables the Multiplexer 204 to multiplex the preferred control signals with one of the AC coupled differential signals.

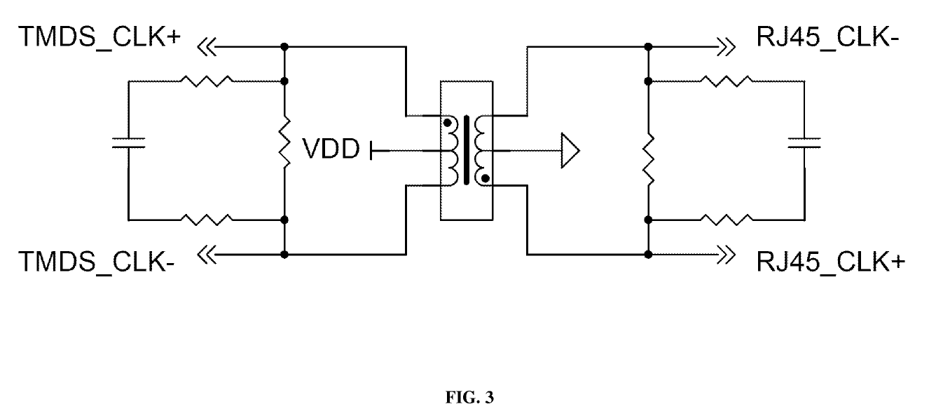

In FIG. 3, there is an example of the circuitry which handles the conversion of CML differential clock signals, TMDS_CLK±, into RJ45 UTP differential clock signals, RJ45_CLK±. These RJ45 UTP differential clock signals establish the ground reference between transmitter 105 and receiver 109 in FIG. 1.

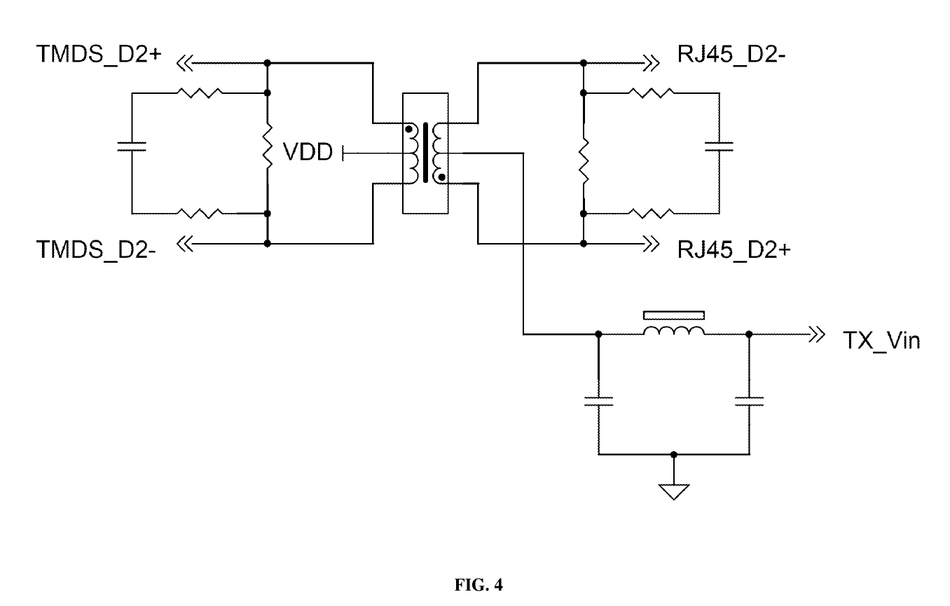

In FIG. 4, the circuitry illustrates the multiplexing of the power with one of the differential signals, TMDS_D2±, which provides power to a receiver, such as receiver 109 in FIG. 1. The Vout is a voltage that is much higher than the required voltage for the receiver to reduce the current on the cable and thus reduce power losses and voltage drop over the cable. This can be done with a simple charge pump or DC-DC converter. The figure also depicts the circuitry of an embodiment of CML converter/multiplexer 204, which transforms the video signal TMDS_D2± into the differential video signals, RJ45_D2±.

FIG. 5 illustrates the circuitry used to convert CML differential video signals, TMDS_D0±, into AC coupled differential signals, RJ45_D0±. It de-multiplexes one of the received control signals, SDA_Rx, which is transmitted from receiver 109 to transmitter 105 in FIG. 1. The AC coupled differential signals are realized by using wide-band impedance matching transformers. The control signal, SDA_Tx, is also multiplexed with the differential signals under the control of the SDA_Multiplex switch. SDA_Tx and SDA_Rx operate in half-duplex mode.

As shown in FIG. 6, the circuitry converts video differential signals, TMDS_D1±, into AC coupled differential signals, RJ45_D1±, and multiplexes them with one of the control signals, SCL_Tx. The AC coupled differential signals are realized through the use of wide-band impedance matching transformers.

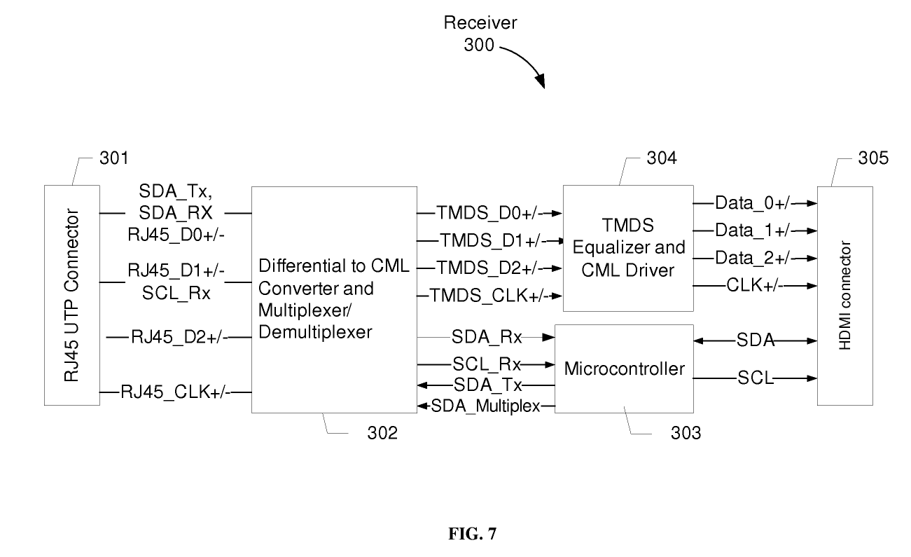

In FIG. 7, model 300 depicts the major function blocks in an embodiment of a receiver, such as the receiver block 109 in FIG. 1.

RJ45 UTP Connector 301 receives signals from the transmitter. The received signals include three pairs of RJ45 differential video signals multiplexed with the preferred control signals and one pair of high-speed RJ45 differential clock signals. The DC coupled digital video signals are transmitted using unshielded or shielded Ethernet CAT5, CAT5e, CAT6 or similar cables that contain 4 twisted pairs.

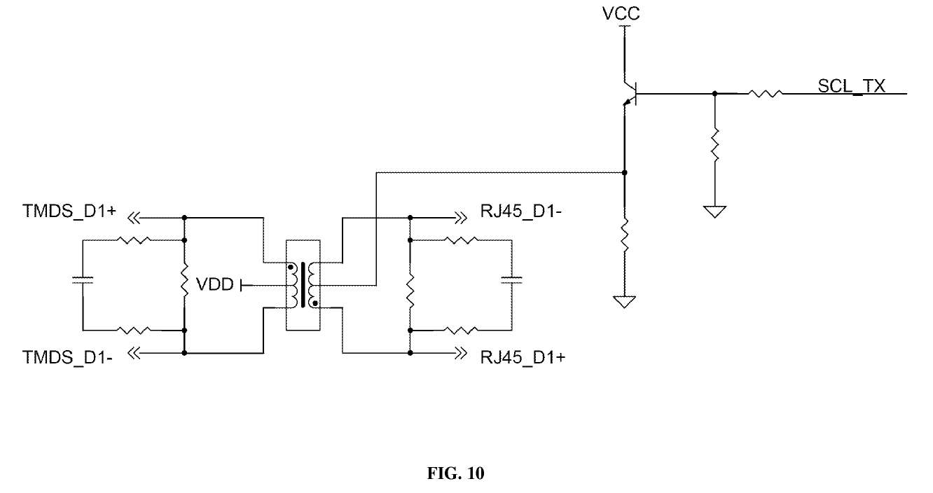

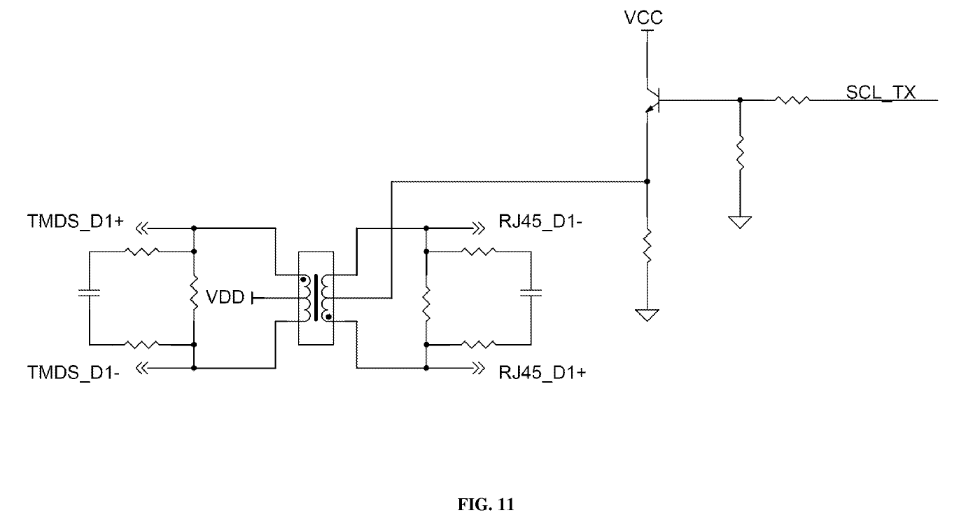

Differential to CML Converter and Muliplexer/Demultiplexer 302 converts RJ45 differential video signals, such as RJ45_D0±, RJ45_D1±, and RJ45_D2±, to CML video signals, such as TMDS_D0±, TMDS_D1±, and TMDS_D2±. It also uses common mode signaling to de-multiplex the control signals, such as SCL_Rx in FIG. 10 and SDA_Rx, SDA_Tx in FIG. 11. The received control signals are transmitted by a transmitter, such as the transmitter 105 in FIG. 1.

As an embodiment of TMDS Equalizer and CML Driver 304, it converts the DC coupled digital video signals, such as TMDS_D0±, TMDS_D1±, and TMDS_D2± back into HMDI or DVI differential video signals, such as data_0±, data_1±, and data_2±.

The control signals SCL_Rx, SDA_Rx/Tx are subsequently sent by Microcontroler 303 to an embodiment of Display 113 in FIG. 1 through HMDI or DVI connector 305 over HMDI or DVI cable/cables.

HDMI connector 305 connects with a target application, such as Display 103 in FIG. 1, through HDMI or DVI cable 102 in FIG. 1.

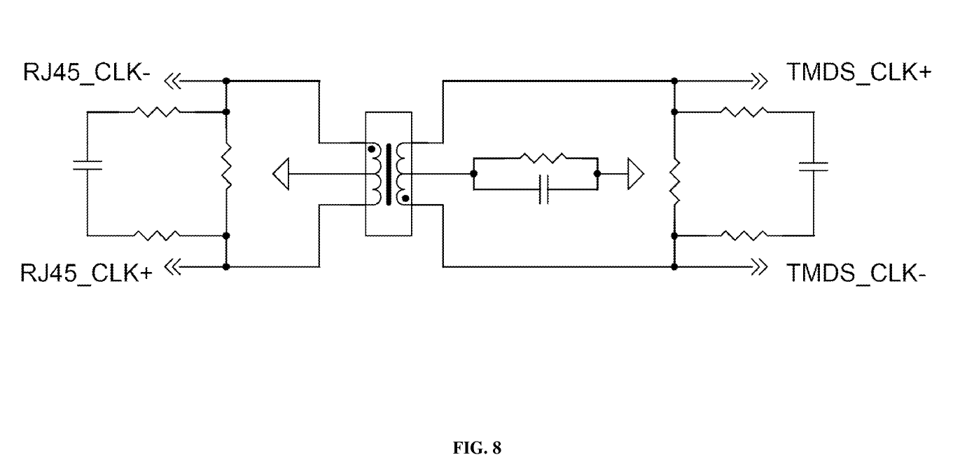

FIG. 8 depicts the circuitry used to convert RJ45 UTP differential clock signals to CML clock signals, which are used to synchronize between the receiver and transmitter. The ground reference is re-established between transmitter 105 and receiver 109 in FIG. 1.

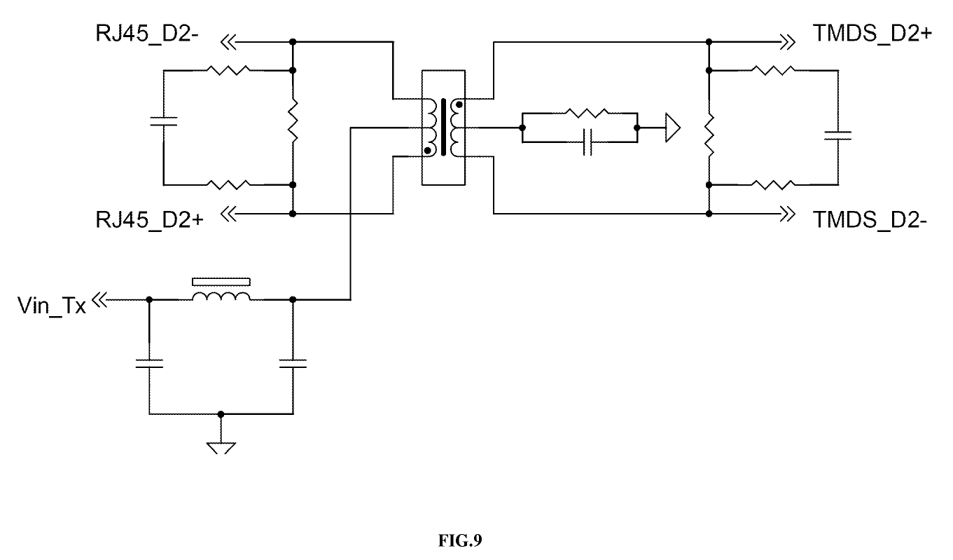

FIG. 9 shows the circuitry used to de-multiplex the power from the differential video signals to get power from the transmitter. The Vin can be converted into the required voltage with a simple linear regulator or a DC-DC converter.

FIG. 9 also shows the circuitry used to create differential digital video signal TMDS_D2± from received RJ45 differential video signals RJ45_D2±.

FIG. 10 depicts the circuitry used to create differential digital video signal TMDS_D1± from received RJ45 differential video signals RJ45_D1±. Control signal SCL_Rx is detected, and common mode signaling is realized by using the center-tap of the wide-band impedance matching transformers.

FIG. 11 shows the circuitry used to create differential digital video signal TMDS_D0± from received RJ45 differential video signals RJ45_D0±. Under the control of micro-controller 303 in FIG. 7, control signal SDA_Tx is multiplexed with RJ45_D0± and be transmitted back to the Transmitter 105 in FIG. 1, and control signal SDA_Rx is de-multiplexed from RJ45_D0±.

The invention explained above refers to a preferred embodiment. Other embodiments will be apparent to those skilled in the art in light of this disclosure. For example, the present invention may be readily implemented using configurations other than those described in the preferred embodiment above. Additionally, the present invention may be effectively used in conjunction with systems other than the one described above as the preferred embodiment. Therefore, these and other variations upon the preferred embodiments are intended to be covered by the present invention, which is limited only by the appended claims.

What is claimed is:

1. An apparatus of using a single Ethernet CAT cable to extend HDMI and DVI signals.

2. The apparatus of claim 1 wherein said Ethernet CAT cable includes both shielded and unshielded Ethernet CAT5, CAT5e, CAT6 and similar cables that contain 4 twisted pairs.

3. The apparatus of claim 1 wherein said extend is used to convert the original DC coupled CML (Current Mode Logic) video signals to AC coupled differential signals, and use common mode signaling to carry the control signals.

4. The apparatus of claim 3 wherein said AC coupled differential signals are realized through the wide-band impedance matching transformers.

5. The apparatus of claim 3 wherein said common mode signaling is realized by using the center-tap of the said wide-band impedance matching transformers.

6. The apparatus of claim 1 further composes of the DC restore circuitry to convert the said AC coupled differential signals back to the original CML signals.

7. The apparatus of claim 6 wherein said convert the said AC coupled differential signals back to the original CML signals is realized through the use of wide-band impedance matching transformers.
